(19) United States
(12) Patent Application Publication
(10) Pub. No.: US 2023/0098009 A1
(43) Pub. Date: Mar. 30, 2023

(54) SNS ANALYSIS SYSTEM, SNS ANALYSIS DEVICE, SNS ANALYSIS METHOD, AND RECORDING MEDIUMSTORING SNS ANALYSIS PROGRAM

(71) Applicant: NEC CORPORATION, Minato-ku, Tokyo (JP)

(72) Inventor: Ryosuke TOGAWA, Tokyo (JP)

(73) Assignee: NEC Corporation, Minato-ku, Tokyo (JO)

(21) Appl. No.: 17/907,755

(22) PCT Filed: Mar. 27, 2020
(86) PCT No.: PCT/JP2020/014061

§ 371 Date: Aug. 29, 2022

(51) Int. Cl. G06Q 50/26; G06Q 50/22; G01W 1/10

(52) U.S. Cl. CPC G06Q 50/26; G06Q 50/22; G01W 1/10

(57) ABSTRACT

An SNS analysis system 30 improves the precision of estimating the existence of an unknown relationship among multiple persons in an SNS, wherein the improvement being achieved by comprising an estimation unit 32 that estimates the existence of an unknown relationship among a second plurality of persons on the basis of: an estimation model 31 that represents a relationship between communication history information 310 related to a first plurality of persons (which represents time-series variations in at least either giving and receiving of information via the SNS among persons or persons' transmitting of information related to each other via the SNS) as well as attribute information 313 (which represents time-series variations in attributes of persons) and presence-or-absence 314 of a relationship existing among the first plurality of persons; and communication history information 300 as well as attribute information 303 both related to the second plurality of persons.

### TECHNICAL FIELD

The present invention relates to an SNS analysis system, an SNS analysis device, an SNS analysis method, and a recording medium storing an SNS analysis program.

### BACKGROUND ART

It is very important to predict in advance the occurrence of a crime such as a terror and prevent the occurrence in advance in order to construct a safe society. Therefore, a technology for predicting occurrence of a crime in advance is expected.

As a technology related to such a technology, PTL 1 discloses a system in which a crime prediction server that collects crime related information related to an incident is connected to a center device having a display unit that displays the crime related information. The crime prediction server in this system accesses a social networking service (SNS) server and collects pieces of posted information including a crime-related word from among pieces of posted information of ordinary people as crime related information. The crime prediction server calculates statistical data for each attribute including an occurrence point of a crime, an occurrence time, and a crime type regarding the crime related information to transmit the crime data and the map data extracted from the statistical data of the crime related information in response to a request from the center device. Then, the center device in this system superimposes the crime data for each attribute on the map data on the display unit, and plots and displays the crime data at a location relevant to the crime occurrence point on the map.

PTL 2 discloses a system that stores crime data and weather data, and determines a crime prediction by adjusting a past crime rate based on a correlation between predicted weather conditions and the crime data. The system further stores event data and determines a crime prediction by further adjusting a past crime rate based on a correlation between future events and crime data.

### CITATION LIST

### Patent Literature

[PTL 1] JP 2018-061216 A
[PTL 2] JP 2018-505474 A

### Non Patent Literature

[NPL 1] Lu Wang, Wenchao Yu, Wei Wang, Wei Cheng, Wei Zhang, Hongyuan Zha, Xiaofeng He, Haifeng Chen, “Learning Robust Representations with Graph Denoising Policy Network”, arXiv:1910.01784, Oct. 4, 2019
[NPL 2] Dongkuan Xu, Wei Cheng, Dongsheng Luo, Xiao Liu, Xiang Zhang, “Spatio-Temporal Attentive RNN for Node Classification in Temporal Attributed Graphs”, Twenty-Eighth International Joint Conference on Artificial Intelligence Main track, Pages 3947-3953, Aug. 11-12, 2019
[NPL 3] Wenchao Yu, Wei Cheng, Charu Aggarwal, Kai Zhang, Haifeng Chen, Wei Wang, “NetWalk: A Flexible Deep Embedding Approach for Anomaly Detection in Dynamic Networks”, KDD 2018, August 19-23, 2018, London, United Kingdom

### SUMMARY OF INVENTION

### Technical Problem

One of methods for predicting occurrence of a crime in advance, includes identifying a person requiring attention who is highly likely to commit a crime from communication contents related to activities on an SNS or an analysis result of an SNS account. Since a particularly highly dangerous crime is often performed systematically, it is important to identify a person requiring attention involved in an organized crime at an early stage by estimating an unknown relationship between the persons requiring attention from analysis results of activities and accounts on the SNS in order to prevent the crime in advance. The unknown relationship is, for example, a relationship in which a follow-follower relationship is not established on the SNS but an acquaintance relationship is established in the real world.

In order to estimate an unknown relationship between the persons (users) in an SNS with high accuracy, it is necessary to estimate the unknown relationship in consideration of various factors that complicatedly affect each other. Such factors include, for example, a feature of a time-series change (transition) in the content of communication performed by the person in the SNS, a feature of a time-series change in the attribute of the person, and the like. Therefore, in order to estimate the unknown relationship between the persons in the SNS with high accuracy, it is necessary to grasp and analyze the features of the time-series change regarding the activity on the SNS with high accuracy.

However, in a general system that analyzes communication performed in an SNS, a feature of a time-series change regarding contents of communication in such an SNS cannot be sufficiently grasped. Therefore, in a general system, in particular, in a case where the feature of the time-series change is an important factor in the estimation of the unknown relationship between the persons, the estimation accuracy is greatly reduced. It cannot be said that the techniques disclosed in PTLs 1 and 2 described above are sufficient to solve this problem.

A main object of the present invention is to provide an SNS analysis system and the like capable of improving the accuracy with which existence of an unknown relationship between a plurality of persons is estimated in an SNS.

### Solution to Problem

An SNS analysis system according to an aspect of the present invention includes an estimation means configured to estimate, based on an estimation model representing a relationship between communication history information and attribute information related to a first plurality of persons and presence or absence of a relationship existing between the first plurality of persons and the communication history information and the attribute information related to a second plurality of persons, existence of an unknown relationship between the second plurality of persons, wherein the communication history information represents a time-series change in at least any of exchange of information between the first plurality of persons or the second plurality of persons via an SNS and transmission of information related to each other by the first plurality of persons or the second plurality of persons via the SNS, and the attribute information indicates a time-series change in attributes of the first plurality of persons or the second plurality of persons.

In another viewpoint of achieving the above object, an SNS analysis method according to an aspect of the present invention includes an information processing system estimating, based on an estimation model representing a relationship between communication history information and attribute information related to a first plurality of persons and presence or absence of a relationship existing between the first plurality of persons and the communication history information and the attribute information related to a second plurality of persons, existence of an unknown relationship between the second plurality of persons, wherein the communication history information represents a time-series change in at least any of exchange of information between the first plurality of persons or the second plurality of persons via an SNS and transmission of information related to each other by the first plurality of persons or the second plurality of persons via the SNS, and the attribute information indicates a time-series change in attributes of the first plurality of persons or the second plurality of persons.

In a further viewpoint of achieving the above object, an SNS analysis program according to an aspect of the present invention causes a computer to execute an estimation process of estimating, based on an estimation model representing a relationship between communication history information and attribute information related to a first plurality of persons and presence or absence of a relationship existing between the first plurality of persons and the communication history information and the attribute information related to a second plurality of persons, existence of an unknown relationship between the second plurality of persons, wherein the communication history information represents a time-series change in at least any of exchange of information between the first plurality of persons or the second plurality of persons via an SNS and transmission of information related to each other by the first plurality of persons or the second plurality of persons via the SNS, and the attribute information indicates a time-series change in attributes of the first plurality of persons or the second plurality of persons.

Furthermore, the present invention can also be achieved by a computer-readable non-volatile recording medium storing the SNS analysis program (computer program).

### Advantageous Effects of Invention

According to the present invention, it is possible to obtain an SNS analysis system or the like capable of improving the accuracy with which existence of an unknown relationship between a plurality of persons is estimated in an SNS.

### BRIEF DESCRIPTION OF DRAWINGS

FIG. 1 is a block diagram illustrating a configuration of an SNS analysis system 10 according to a first example embodiment of the present invention.

FIG. 2 is a diagram illustrating contents of follow result information 101 according to the first example embodiment of the present invention.

FIG. 3 is a diagram illustrating contents of posted information 102 according to the first example embodiment of the present invention.

FIG. 4 is a diagram illustrating contents of attribute information 103 according to the first example embodiment of the present invention.

FIG. 5 is a diagram illustrating a configuration of a graph 120 according to the first example embodiment of the present invention.

FIG. 6 is a diagram illustrating a procedure in which a graph generation unit 12 according to the first example embodiment of the present invention generates the graph 120 used as teacher data when a model generation unit 13 generates an estimation model 130.

FIG. 7 is a flowchart illustrating an operation (processing) in which the SNS analysis system 10 according to the first example embodiment of the present invention generates the estimation model 130 (performs machine learning).

FIG. 8 is a diagram illustrating a mode in which a display control unit 15 according to the first example embodiment of the present invention displays an estimation result on a display screen 200.

FIG. 9 is a flowchart illustrating an operation in which the SNS analysis system 10 according to the first example embodiment of the present invention estimates existence of an unknown relationship between a plurality of persons.

FIG. 10 is a block diagram illustrating a configuration of an SNS analysis system 30 according to a second example embodiment of the present invention.

FIG. 11 is a block diagram illustrating a configuration of an information processing system 900 capable of achieving the SNS analysis system 10 according to the first example embodiment or the SNS analysis system 30 according to the second example embodiment of the present invention.

### EXAMPLE EMBODIMENT

A system exemplifying the example embodiment to be described later uses a learned model (also referred to as an estimation model) generated by machine learning (for example, deep learning) when estimating a target event from certain input information. Then, the system uses, for example, a graph including a node and an edge (also referred to as an edge) representing the input information. The graph changes in structure over time. The idea of the system has come when applying an algorithm capable of analyzing features of such a graph. As this algorithm, for example, the following algorithm is known.

(1) TGFN (Temporal Graph Factorization Network)

It is an algorithm that extracts a static feature that is unchanged regardless of time and a dynamic feature unique to each time from a graph whose structure changes with the lapse of time, and analyzes the extracted feature. Since this algorithm is disclosed in NPL 1, the detailed description thereof will be omitted in the example embodiment described later.

(2) STAR (Spatio-Temporal Attentive RNN)

It is an algorithm for identifying and analyzing, from a graph whose structure changes with the lapse of time, a node that is important (that is, the degree of influence on estimation is high.) on estimation of a certain event, for example, on each of a time axis and a spatial axis among nodes constituting the graph. Since this algorithm is disclosed in NPL 2, the detailed description thereof will be omitted in the example embodiment described later.

(3) Netwalk

It is an algorithm for extracting a feature amount of a node constituting a graph from the graph whose structure changes with time. Since this algorithm is disclosed in NPL 3, the detailed description thereof will be omitted in the example embodiment described later.

The disclosure exemplifying the example embodiment to be described later achieves improvement in accuracy with which a target event is estimated by applying the above-described algorithm when generating a learned model and when estimating the target event from certain input information using the learned model.

Hereinafter, example embodiments of the present invention will be described in detail with reference to the drawings.

### First Example Embodiment

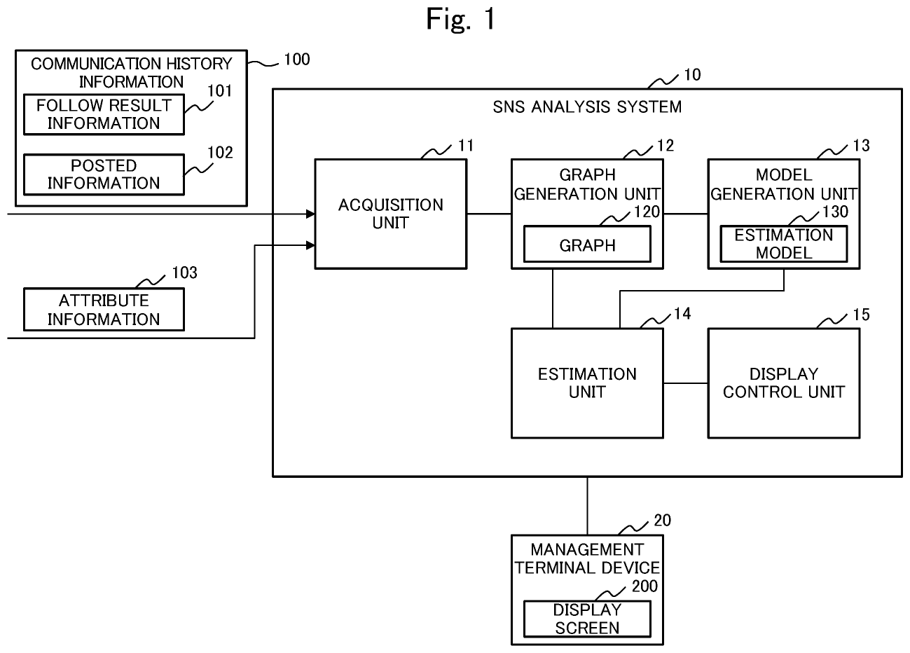

FIG. 1 is a block diagram illustrating a configuration of an SNS analysis system 10 according to a first example embodiment of the present invention. The SNS analysis system 10 according to the present example embodiment is a system that estimates existence of an unknown relationship between the persons in an SNS based on information related to contents of communication performed by the person (hereinafter, also referred to as a “user who uses the SNS” or an “SNS user”.) in the SNS, an attribute of the person, and the like. The SNS analysis system 10 generates, for a plurality of persons, a learned model (also referred to as an estimation model) using information related to a communication history to which existence of a relationship which was unknown up to a certain time point in the past and that is recognized thereafter is assigned as a label and information related to an attribute and the like of a person. Then, the SNS analysis system 10 estimates existence of the unknown relationship using the learned model. The SNS analysis system 10 includes at least one or more information processing apparatuses.

A management terminal device 20 (also referred to as a display device) is communicably connected to the SNS analysis system 10. The management terminal device 20 is, for example, a personal computer or another information processing apparatus used when a user (hereinafter, also referred to as an “administrator”) who uses the SNS analysis system 10 inputs information to the SNS analysis system 10 or confirms information output from the SNS analysis system 10. Management terminal device 20 includes a display screen 200 that displays the information output from the SNS analysis system 10.

The SNS analysis system 10 includes an acquisition unit 11, a graph generation unit 12, a model generation unit 13, an estimation unit 14, and a display control unit 15. The graph generation unit 12, the model generation unit 13, the estimation unit 14, and the display control unit 15 are examples of a graph generation means, a model generation means, an estimation means, and a display control means, respectively.

Next, an operation in which the SNS analysis system 10 according to the present example embodiment generates or updates an estimation model 130 for estimating existence of an unknown relationship between a plurality of persons and an operation in which the SNS analysis system estimates the unknown relationship using the estimation model 130 will be described.

<Operation of Generating (Updating) Estimation Model 130>

First, an operation in which the SNS analysis system 10 according to the present example embodiment generates or updates the estimation model 130 for estimating existence of an unknown relationship between a plurality of persons in the SNS will be described.

The acquisition unit 11 acquires communication history information 100 and attribute information 103 regarding a plurality of persons (also referred to as first plurality of persons) to be learned in a predetermined period from a computer device (not illustrated) or a database via a network. Acquisition unit 11 may, for example, periodically acquire the communication history information 100 and the attribute information 103. Alternatively, for example, the acquisition unit 11 may acquire the communication history information 100 and the attribute information 103 according to an instruction input by the user via the management terminal device 20.

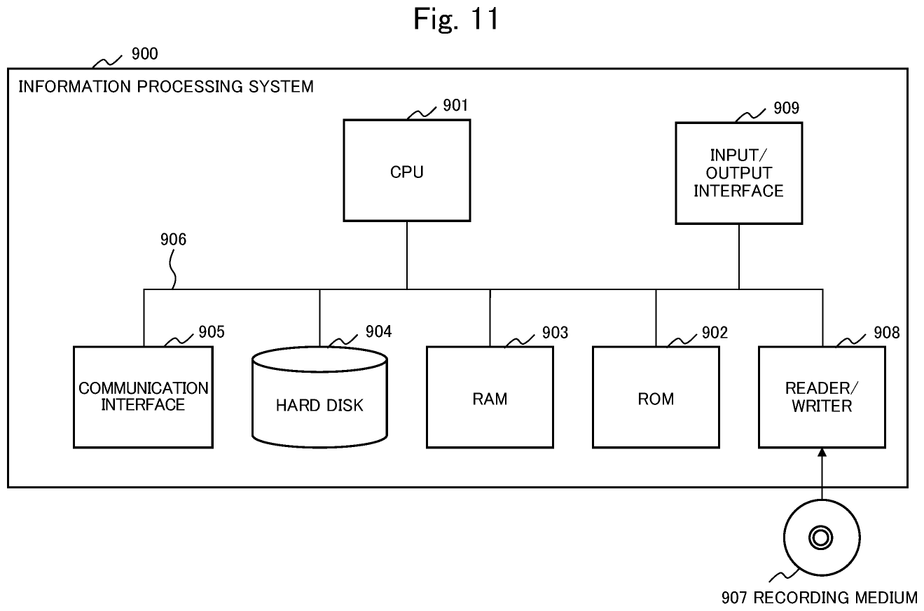

Acquisition unit 11 includes, for example, a communication circuit connected to one or a plurality of computer devices or databases that transmit the communication history information 100 and the attribute information 103, and a storage device that stores information acquired by the communication circuit. The storage device may be a hard disk 904 or a RAM 903 of an information processing system 900 illustrated in FIG. 11 described later.

The communication history information 100 is information indicating a time-series change (transition) in communication performed by a plurality of persons via the SNS. The communication history information 100 includes follow result information 101 and posted information 102.

Communication history information 100 includes SNS account information and SNS activity information of a plurality of SNS users.

The SNS account information is information related to an account of the SNS user. For example, the SNS account information includes identification information (name, nickname, ID, etc.), residential place information (address, etc.), work place information (company name, workplace address, etc.), a telephone number, an email address, and the like of the SNS user. The SNS account information is not limited thereto, and may include various pieces of information registered by the SNS user at the time of account creation.

The SNS activity information is information related to activity on the SNS performed by the SNS user via the SNS account. The SNS activity information includes, for example, the following information.
Follower information related to an account of another SNS user who are followed
Follow information on an account of another SNS user who is following
The number of impressions indicating the number of times the SNS user viewed the advertisement
The number of engagements indicating the number of times the SNS user reacted to the advertisement viewed
An engagement rate (a value obtained by dividing the number of impressions by the number of engagements)
The number of replays of a moving image posted by another user,
The number of clicks of a link included in a posted content of another user
The number of clicks of an image or a moving image posted by another SNS user
The number of likes for a post of another SNS user
The number of retweets (or the number of shares) for a post of other SNS users
The number of replies to a post of another user
The number of times of opening the details of the post of another SNS user
The number of clicks on the profile of another SNS user
A message content (for example, the content of the direct message) exchanged with another user
The number of times of exchanging messages with another SNS user (for example, the number of times of exchange of direct messages)
Search content
Posted contents browsed as a result of search
Location information indicating a place where the SNS user has posted

The SNS activity information is not limited thereto, and may include various pieces of information related to activity on the SNS or interaction with another user.

Note that the follow result information 101 and the posted information 102 may each include SNS account information and SNS activity information.

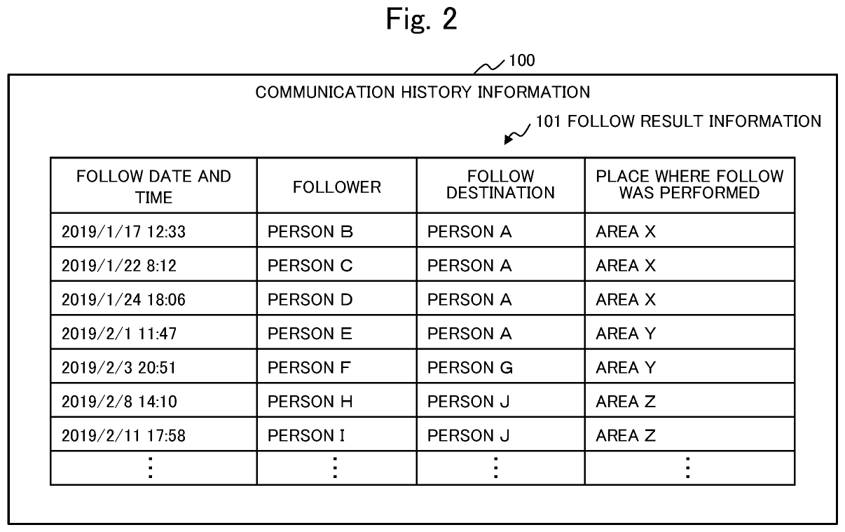

FIG. 2 is a diagram illustrating contents of data of the follow result information 101 according to the present example embodiment. The follow result information 101 indicates a result of a certain person following another person in the SNS. The follow result information 101 includes a date and time when the follow was performed, a person of a follower (follower source), a person of a follow destination, and a place where the follower performed the follow. The follow result information 101 may include, for example, an item other than the items illustrated in FIG. 2, such as a comment posted when the follower performs the follow.

In the follow result information 101 illustrated in FIG. 2, it is assumed that the follower and the person of the follow destination are represented by an identification (ID) capable of identifying the person. It is assumed that the place where the follow was performed is also represented by an ID capable of identifying the place. Note that the place where the follow was performed indicates a location where the follower performed the follow (communication), for example, by operating the terminal device. The place where the follow was performed can be identified from information such as an internet protocol (IP) address indicating a transmission source included in the communication indicating the follow. The information related to the location where the follow (communication) was performed may include information of various granularities such as global navigation satellite system (GNSS) coordinates, regions, countries, and the like.

The follow result information 101 is time-series changing information to which a follow result is added when the follow by a certain person is performed.

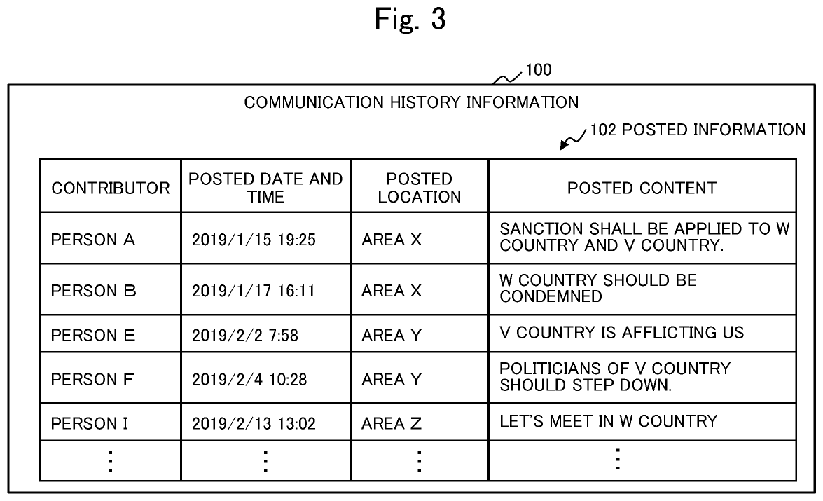

FIG. 3 is a diagram illustrating contents of data of the posted information 102 according to the present example embodiment. The posted information 102 represents information posted by a certain person to the SNS. The posted information 102 includes a person who performed posting, a date and time of posting, a place where the person performed posting, and a posted content. The posted information 102 may include an item other than the items exemplified in FIG. 3.

Although the posted information 102 illustrated in FIG. 3 includes a posted content represented by a text, the posted information 102 may include a posted content represented by, for example, a voice, an image (a still image or a moving image), or the like.

The posted information 102 is information that changes in time series and to which a posted result is added when posting to the SNS by a certain person is performed.

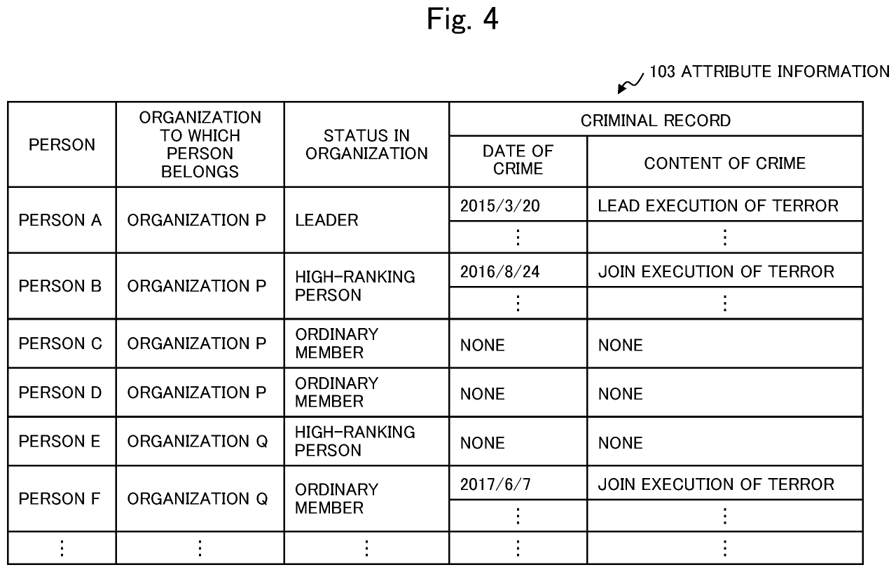

FIG. 4 is a diagram illustrating contents of data of the attribute information 103 according to the present example embodiment. The attribute information 103 illustrated in FIG. 4 indicates, for each person, an organization to which a person belongs (for example, a criminal organization), a status in the organization, and a criminal record (a date of a crime and a content of a crime) as the attribute of the person. The attribute information 103 is, for example, information created by the police or the like. Note that the attribute information 103 may include an item representing the attribute of the person different from the items exemplified in FIG. 4, or may include at least one or more of the items exemplified in FIG. 4. The attribute information 103 may be included in the SNS account information, and the attribute information 103 may include the SNS account information.

The organization to which a person belongs and the status in the organization in the attribute information 103 are changed when the situation in which the person belongs to the organization changes, and the criminal record is added when the person newly commits a crime, so that the attribute information 103 is information that changes in time series.

The acquisition unit 11 stores the follow result information 101, the posted information 102, and the attribute information 103 acquired as described above in a storage device (not illustrated) (for example, a memory, a hard disk, or the like).

The graph generation unit 12 illustrated in FIG. 1 generates a graph 120 representing the follow result information 101, the posted information 102, and the attribute information 103 acquired by the acquisition unit 11 in a predetermined period. Specifically, the graph generation unit 12 reads the follow result information 101, the posted information 102, and the attribute information 103 from the storage device, and generates a graph 120 based on the graph generation algorithm. In this case, the graph 120 represents a time-series change (transition) in a predetermined period regarding communication performed by a plurality of persons via the SNS and attributes of the plurality of persons.

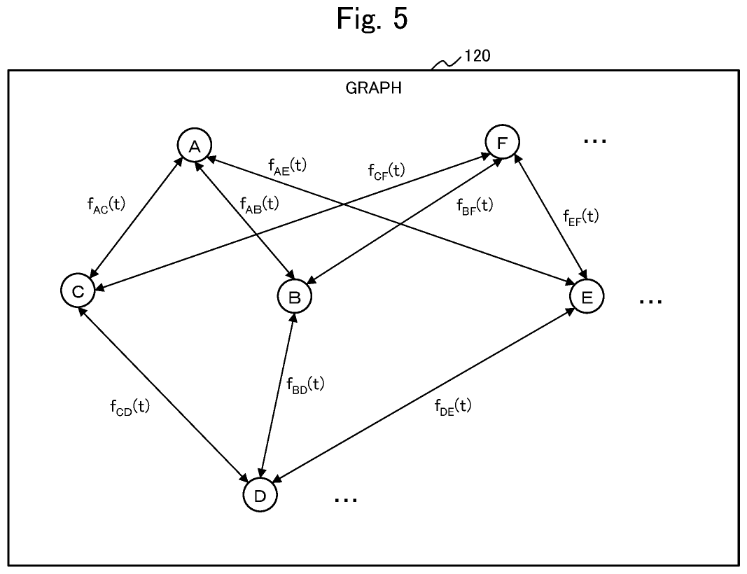

FIG. 5 is a diagram illustrating a configuration of the graph 120 according to the present example embodiment. As illustrated in FIG. 5, graph 120 includes nodes representing a plurality of persons (person A, person B, and the like). Further, the graph 120 includes an edge, connecting nodes, which indicate a relationship between a plurality of persons via the SNS. In the example of FIG. 5, the node is indicated by a circle surrounding the person's name, and the edge is indicated by an arrow, but the present invention is not limited thereto. For example, the edge may be represented by not an arrow but a line that does not indicate a direction.

Each node in the graph 120 includes attribute information of a person. More specifically, the nodes in graph 120 include the attribute information 103. Therefore, each node is represented by a multi-dimensional function including the item (for example, an organization to which a person belongs, a status in the organization, a criminal record, and the like.) included in the attribute information 103 as an element with time t as a variable. A multi-dimensional function representing a node is stored in a storage device (not illustrated) (for example, the hard disk 904 or the RAM 903) in association with information indicated by the node.

More specifically, each edge in the graph 120 is associated with the follow result information 101 and the posted information 102. For example, an edge connecting a node indicating the person A and a node indicating the person B represents a result of following the person A by the person B indicated by the follow result information 101, and is represented by a function f_{AB} (t) illustrated in FIG. 5.

The relevance between the content posted by the person A and the content posted by the person B indicated by the posted information 102 is also represented by the function f_{AB} (t) illustrated in FIG. 5. The relevance is, for example, similarity. The graph generation unit 12 can obtain the similarity between the text indicating the content posted by the person A and the text indicating the content posted by the person B indicated by the posted information 102 based on a keyword or the like extracted from the texts, for example, using an existing sentence analysis technology.

In a case where a posted content included in the posted information 102 is represented by a voice, the graph generation unit 12 may convert the posted content into a text using, for example, an existing voice recognition technique, and perform the above-described processing on the text for obtaining similarity. In a case where a posted content included in the posted information 102 is represented by an image, the graph generation unit 12 may convert the posted content into text using, for example, an existing image recognition technique, and perform the above-described processing on the text for obtaining similarity.

As described above, the function such as the function f_{AB} (t) representing each edge is a multi-dimensional function including the item (for example, follow relationship) included in the follow result information 101 and the item (for example, the relevance of the posted content) included in the posted information 102 as elements with time t as a variable. A multi-dimensional function representing an edge is stored in a storage device (not illustrated) (for example, the hard disk 904 or the RAM 903) in association with the edge.

The graph generation unit 12 further assigns a label to the graph 120 for teacher data generated for a predetermined period and used when the model generation unit 13 described later performs machine learning. The graph generation unit 12 sets, as the label, the presence or absence of a relationship, existing between a plurality of persons, that is unknown in the predetermined period but is known after the predetermined period.

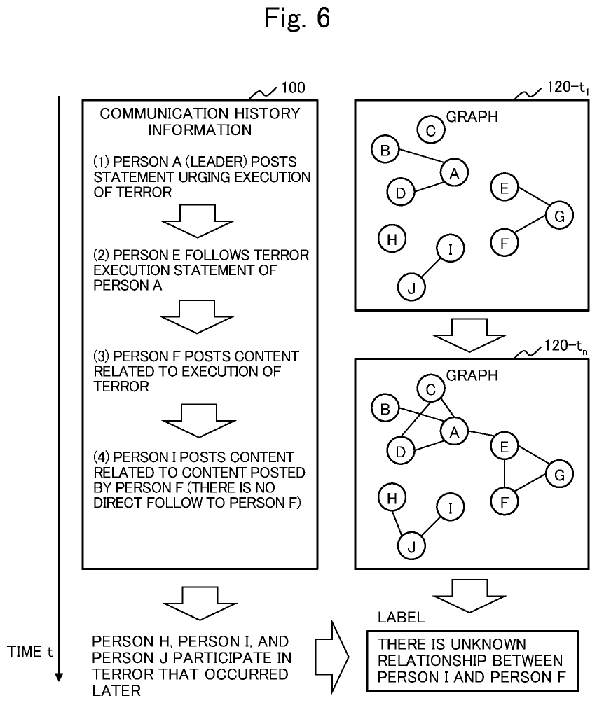

FIG. 6 is a diagram illustrating a procedure in which the graph generation unit 12 generates the graph 120 used as teacher data when the model generation unit 13 described later generates the estimation model 130. The communication history information 100 illustrated in FIG. 6 indicates that the following events have occurred in chronological order with respect to communication performed by a plurality of persons via the SNS in a predetermined period.

(1) the person A (LEADER of a criminal organization) posted a statement urging execution of the terror.

(2) the person E followed the statement of execution of the terror by the person A.

(3) the person F posted a content related to execution of the terror.

(4) the person I has posted a content related to the content posted by the person F (However, there is no direct follow from the person I to the person F.).

Based on communication history information 100 indicating a time-series change in communication performed by the plurality of persons via the SNS, the graph generation unit 12 generates the graph 120 indicating a time-series change in the communication and used as teacher data. A graph 120-t₁ and a graph 1204 illustrated in FIG. 6 are snapshots of the graph 120 at times t₁ and tₙ (n is any integer of 2 or more) in the predetermined period. Note that time t₁ represents the start of the predetermined period, and time tₙ represents the end of the predetermined period. As illustrated in FIG. 6, the graph 1204 includes edges (that is, a relationship between the persons via the SNS) that are not present in the graph 120-t₁. An edge not present in the graph 120-t₁ represents a relationship, between the persons, in which existence is newly found from communication performed by a plurality of persons via the SNS in the predetermined period.

Note that the graph generation unit 12 may generate (draw) a function graph instead of the graph structure data as described above. In this case, for example, the graph generation unit 12 may generate a graph (function) in which a horizontal axis represents time (date and time) and a vertical axis represents an index indicating an SNS activity.

In the example illustrated in FIG. 6, it is assumed that existence of the relationship between the person F and the person I is unknown at the end of the predetermined period (that is, time tₙ). Then, it is assumed that a terror incident in which the person H, the person I, and the person J participate occurs after the predetermined period. In this case, the graph generation unit 12 assigns, as a label, existence of an unknown relationship between the person I and the person F with respect to the graph 120 used as the teacher data.

Such labeling may be performed, for example, by the user determining existence of an unknown relationship based on the content of the time-series change in communication performed via the SNS indicated by the communication history information 100 and the fact that the terror incident in which the person I participated occurred. Alternatively, the graph generation unit 12 may perform such labeling according to a predetermined labeling criterion based on the content of the time-series change in the communication performed via the SNS indicated by the communication history information 100 and the information indicating the fact that the terror incident in which the person I participated occurred. The graph generation unit 12 stores the configuration of the graph 120 to which a label is assigned as described above in the storage device. The graph generation unit 12 outputs the labeled graph 120, as teacher data, to the model generation unit 13.

Using the labeled graph 120, as teacher data, input from the graph generation unit 12, the model generation unit 13 generates the estimation model 130 (learned model) to be used when an estimation unit 14 described later estimates existence of an unknown relationship between the persons. The model generation unit 13 performs machine learning for generating the estimation model 130 (learned model) using the above-described teacher data by the processor.

Specifically, the model generation unit 13 extracts, from the input graph 120, features of time-series changes regarding communication between a plurality of persons via the SNS and attributes of the plurality of persons using a predetermined algorithm. The model generation unit 13 can use, for example, TGFN, STAR, Netwalk, or the like described above as the predetermined algorithm.

By using, for example, TGFN, the model generation unit 13 extracts, from the graph 120, static features and dynamic features that change with time regarding communication between a plurality of persons via the SNS and attributes of the plurality of persons. Alternatively, for example, by using STAR, the model generation unit 13 extracts a node that is important (that is, the degree of influence on estimation is high.) in estimating existence of an unknown relationship between the persons on each of a time axis (a viewpoint over a certain period of time) and a spatial axis (a viewpoint focusing on individual times). Alternatively, the model generation unit 13 extracts the feature amount of the node from the graph 120 by using, for example, Netwalk. When Netwalk is used, the model generation unit 13 may combine it with an existing prediction algorithm such as gradient boosting, for example.

Next, in the process of performing machine learning using the above-described teacher data, the model generation unit 13 determines an explanatory variable related to existence of the unknown relationship between the persons from the result of extracting the feature from the graph 120 as described above. A specific example of the explanatory variable will be described later. Specifically, the result of extracting the feature from the graph 120 is the static features and the dynamic features regarding communication between a plurality of persons via the SNS and attributes of the plurality of persons, or feature amounts of nodes. Then, the model generation unit 13 generates the estimation model 130 including a criterion for estimating existence of the unknown relationship between the persons based on the value of the explanatory variable. The model generation unit 13 determines the criterion by performing machine learning on the relationship between the value of the explanatory variable and the value of the label in the teacher data.

Model generation unit 13 determines an explanatory variable related to, for example, a time-series change in communication activity via the SNS, the explanatory variable being indicated by communication history information 100. The explanatory variable represents, for example, a relationship between a follower and a follow destination, a communication content, a place where communication is performed, and the like, but is not limited thereto. For example, the model generation unit 13 determines an explanatory variable related to, for example, the time-series change in the attribute of the person indicated by the attribute information 103. The explanatory variable represents, for example, an organization to which the person belongs, a status in the organization, and the like, but is not limited thereto.

When determining the explanatory variable as described above, the model generation unit 13 also determines the degree of importance on estimation of existence of the unknown relationship between the persons (contribution to the estimation result) for each of the plurality of explanatory variables. The model generation unit 13 may weight the value of each explanatory variable by the degree of importance of the explanatory variable in the criterion for estimating existence of the unknown relationship between the persons described above. At this time, the model generation unit 13 may determine a different degree of importance for each target person from a difference in feature between the target persons related to the communication history information 100 and the attribute information 103 with respect to the same explanatory variable. That is, for example, with respect to a certain explanatory variable, the model generation unit 13 may set the importance on estimation of existence of the unknown relationship between the person A and the person B to be high, and may set the importance on estimation of existence of the unknown relationship between the person C and the person D to be low.

The model generation unit 13 stores the estimation model 130 generated or updated as described above in a non-volatile storage device (not illustrated). The model generation unit 13 can gradually improve the estimation accuracy by updating (also referred to as relearning) the estimation model 130, for example, every predetermined time.

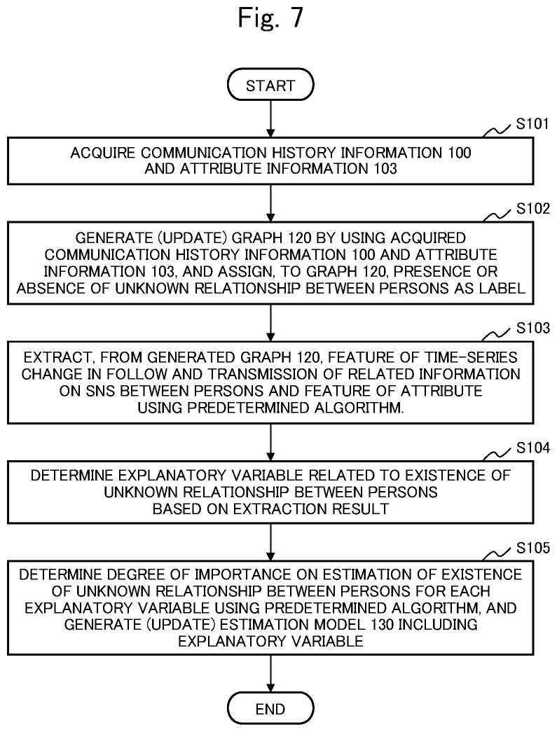

Next, an operation (processing) of generating (performing machine learning) the estimation model 130 by the SNS analysis system 10 according to the present example embodiment will be described in detail with reference to a flowchart of FIG. 7.

The acquisition unit 11 acquires, from the outside, the communication history information 100 and the attribute information 103 related to a plurality of persons used as teacher data (step S101). The graph generation unit 12 generates (updates) the graph 120 by using the communication history information 100 and the attribute information 103 acquired by the acquisition unit 11, and assigns, to the graph 120, the presence or absence of an unknown relationship between the persons as a label (step S102).

Using a predetermined algorithm, the model generation unit 13 extracts, from the graph 120 generated by the graph generation unit 12, a feature of a time-series change in the follow and transmission of related information on the SNS between the persons, and a feature of the attribute (step S103). The model generation unit 13 determines an explanatory variable related to existence of an unknown relationship between the persons based on the extraction result (step S104).

The model generation unit 13 determines the degree of importance on estimation of existence of the unknown relationship between the persons for each explanatory variable using a predetermined algorithm, generates (updates) the estimation model 130 including the explanatory variable (step S105), and ends the entire processing.

<Operation of Estimating Existence of Unknown Relationship Between a Plurality of Persons>

Next, an operation in which the SNS analysis system 10 according to the present example embodiment estimates existence of an unknown relationship between a plurality of persons using the generated or updated estimation model 130 will be described.

The acquisition unit 11 acquires the communication history information 100 and the attribute information 103 from an external device (not illustrated) as in the case where the SNS analysis system 10 generates the estimation model 130. The acquisition unit 11 does not acquire these pieces of information as the above-described teacher data, but acquires these pieces of information as data for estimating existence of an unknown relationship between the persons.

For example, as described above, it is assumed that the estimation model 130 is generated based on the communication history information 100 and the attribute information 103 regarding a plurality of persons (also referred to as a first plurality of persons) involved in a certain crime. In this case, the acquisition unit 11 acquires the communication history information 100 and the attribute information 103 regarding another plurality of persons (also referred to as a second plurality of persons) who is dangerous to commit a crime according to an instruction input by the user via the management terminal device 20, for example. The form of the communication history information 100 and the attribute information 103 related to a plurality of persons to be estimated are similar to that of the communication history information 100 and the attribute information 103 used for generating the estimation model 130 illustrated in FIGS. 2 to 4.

The graph generation unit 12 generates the graph 120 representing the communication history information 100 and the attribute information 103 about a plurality of persons to be estimated. Note that the configuration of the graph 120 is as described above with reference to FIG. 5.

The estimation unit 14 illustrated in FIG. 1 estimates existence of an unknown relationship between a plurality of persons based on the graph 120 for estimating existence of an unknown relationship between a plurality of persons and the estimation model 130.

As in the case where the model generation unit 13 generates or updates the estimation model 130, the estimation unit 14 extracts, from the graph 120 input from the graph generation unit 12, the feature of the time-series change regarding the communication between the plurality of persons via the SNS and the attributes of the plurality of persons. At this time, the estimation unit 14 may use a predetermined algorithm such as TGFN, STAR, or Netwalk described above, for example.

The estimation unit 14 obtains a value of the explanatory variable identified by the estimation model 130 in the graph 120 based on the feature extracted from the graph 120. The estimation unit 14 collates the obtained values of the explanatory variables with a criterion for estimating existence of an unknown relationship between a plurality of persons included in the estimation model 130, thereby estimating existence of the unknown relationship. The features extracted from the graph 120 include, for example, a degree of similarity of persons in the attribute information 103, a degree of similarity of each other's follow results in the follow result information 101, and a time-series feature regarding a time-series change in the SNS activity. The time-series features include, for example, posting timings of posted contents with the same content being similar, following a certain SNS user at the same time, defollowing a certain SNS user at the same time, or the like. Note that the feature extracted from the graph 120 is not limited thereto.

The estimation unit 14 outputs, to the display control unit 15, the result of estimating existence of the unknown relationship between the plurality of persons and information indicating the reason for estimating the existence. The information indicating the reason for estimating the existence is, for example, the value of the explanatory variable in the graph 120 for estimating existence of the unknown relationship, the degree of importance of the explanatory variable, and the like.

The display control unit 15 displays, on the display screen 200 of the management terminal device 20, the result of estimating existence of the unknown relationship between the plurality of persons and the information indicating the reason for estimating the existence, which are input from the estimation unit 14. That is, the display control unit 15 causes the management terminal device 20 to display the estimation result and the estimation reason by the estimation unit 14 on the display screen 200 of the management terminal device 20.

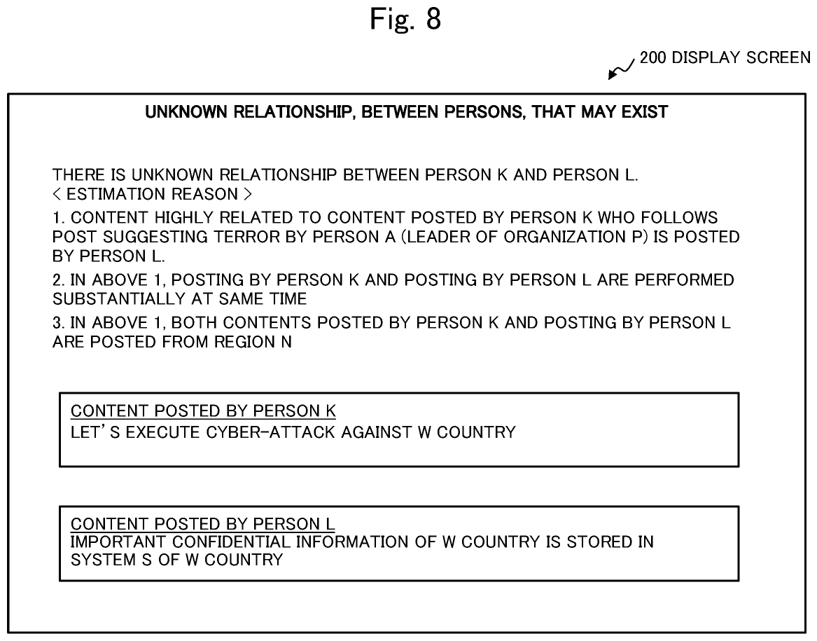

FIG. 8 is a diagram illustrating a mode in which the display control unit 15 according to the present example embodiment displays a result of estimating existence of an unknown relationship between a plurality of persons and information indicating the reason for estimating the existence on the display screen 200.

The display screen 200 illustrated in FIG. 8 indicates that there is an unknown relationship between the person K and the person L. Then, the display screen 200 indicates the reason why the unknown relationship exists between the person K and the person L as follows in descending order of the degree of importance (contribution degree) of the explanatory variable.

1. A content highly related to the content posted by the person K who follows the post suggesting the terror by the person A (leader of the organization P) is posted by the person L.

(The estimation reason in this case is that “the posted content is similar to the post following the person requiring attention”. That is, in this case, the estimation reason is the relationship between the similarity of the posted content with the post following the person requiring attention and existence of an unknown relationship.)

2. In the above 1, the posting by the person K and the posting by the person L are performed at substantially the same time.

(The estimation reason in this case is that “the posting times are similar”. That is, in this case, the relationship between the similarity of the posting times and the existence of an unknown relationship is the estimation reason.)

3. In the above 1, both the posting by the person K and the posting by the person L are performed from the region Z.

(The estimation reason in this case is that “the posting places are similar”. That is, in this case, the relationship between the similarity of the posting places and the existence of an unknown relationship is the estimation reason.)

The SNS analysis system 10 visibly presents the explanatory variable as the estimation reason to the administrator, thereby achieving an effect of improving the explanatory property. The SNS analysis system 10 can also visibly present the relationship between the explanatory variables contributing to the estimation as the reason for estimating existence of the unknown relationship. At this time, the SNS analysis system 10 may visibly present the estimation reason by a mode that is not a natural language sentence as long as the estimation reason can be visually recognized.

Although not illustrated in FIG. 8, for example, the display control unit 15 may display the estimation reason that “the posting timings of the posted contents with the same content are similar, a certain SNS user is followed at the same time, or a certain SNS user is defollowed at the same time” on the display screen 200. The reason for estimating the existence is that “the posting timing of the same content and the change timing of the follow-follower are similar”. That is, in this case, the SNS analysis system 10 presents the feature (time-series feature) of the manner of time-series change in the follow result information 101 and the posted information 102 as the estimation reason. The SNS analysis system 10 can further improve the explanatory property of the estimation result by presenting the time-series change (change timing, etc.) in the explanatory variable in this way.

The display screen 200 illustrated in FIG. 8 displays a content posted by the person K and a content posted by the person L.

In the case of the example illustrated in FIG. 8, regarding communication by a plurality of persons via the SNS, the SNS analysis system 10 uses, as explanatory variables, the level of the relationship between the posted contents, the closeness of the posting time, and the closeness of the posting place.

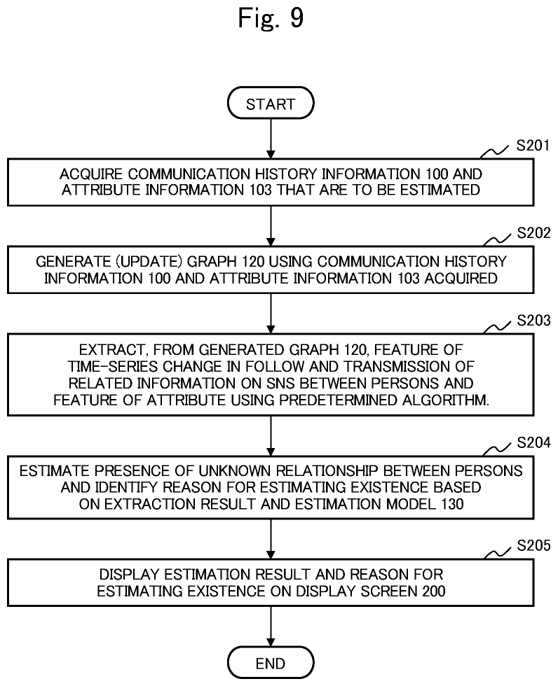

Next, an operation (processing) of estimating existence of an unknown relationship between a plurality of persons by the SNS analysis system 10 according to the present example embodiment will be described in detail with reference to a flowchart of FIG. 9.

The acquisition unit 11 acquires the communication history information 100 and the attribute information 103 to be estimated from the outside (step S201). The graph generation unit 12 generates (updates) the graph 120 using the communication history information 100 and the attribute information 103 acquired (step S202).

The estimation unit 14 extracts, from the graph 120 generated by the graph generation unit 12, a feature of a time-series change in the follow and transmission of related information on the SNS between the persons and a feature of the attribute by using a predetermined algorithm (step S203).

The estimation unit 14 estimates existence of the unknown relationship between the persons based on the feature extraction result from the graph 120 and the estimation model 130, and identifies the reason for estimating the existence (step S204). The display control unit 15 displays the estimation result of the existence of the unknown relationship between the plurality of persons and the reason for estimating the existence by the estimation unit 14 on the display screen 200 of the management terminal device 20 (step S205), and the entire process ends.

The SNS analysis system 10 according to the present example embodiment can improve accuracy with which existence of an unknown relationship between a plurality of persons is estimated in the SNS. This is because the SNS analysis system 10 estimates existence of the unknown relationship between the plurality of persons based on the estimation model 130 generated by using the result of extracting the feature of the time-series change from the information related to the communication between the plurality of persons via the SNS.

Hereinafter, effects achieved by the SNS analysis system 10 according to the present example embodiment will be described in detail.

In order to predict the occurrence of a crime in advance, it is necessary to estimate the relationship in consideration of various factors that complicatedly affect each other in order to estimate an unknown relationship between the persons in the SNS with high accuracy. Such factors include, for example, a feature of a time-series change in the content of communication performed by the person in the SNS, a feature of a time-series change in the attribute of the person, and the like. Therefore, in order to estimate the unknown relationship between the persons in the SNS with high accuracy, it is necessary to analyze the feature of the time-series change related to communication in the SNS with high accuracy. However, in a general system that analyzes communication performed in an SNS, there is a problem that high estimation accuracy cannot be obtained because a feature of a time-series change related to communication in such an SNS cannot be sufficiently grasped.

For such a problem, the SNS analysis system 10 according to the present example embodiment includes the estimation model 130 and the estimation unit 14, and operates as described above with reference to FIGS. 1 to 9, for example. That is, the estimation model 130 is a learned model representing a relationship between the communication history information 100 and the attribute information 103 related to the first plurality of persons and the presence or absence of a relationship existing between the first plurality of persons. The estimation unit 14 estimates existence of the unknown relationship between the second plurality of persons based on the communication history information 100 and the attribute information 103 related to the second plurality of persons and the estimation model 130. The communication history information 100 and the attribute information 103 are information indicating a time-series change related to communication between a plurality of persons via the SNS.

The SNS analysis system 10 according to the present example embodiment generates the graph 120 that represents the communication history information 100 and the attribute information 103, includes nodes and edges, and has a structure changing in time series. Then, the SNS analysis system 10 uses the above-described algorithm such as TGFN, STAR, or Netwalk capable of extracting and analyzing the feature of the generated graph 120, thereby achieving grasping the feature of the time-series change regarding the communication in the SNS with high accuracy. Thus, the SNS analysis system 10 can improve the accuracy with which the unknown relationship between the persons is estimated in the SNS.

In the process of generating the estimation model 130, the SNS analysis system 10 according to the present example embodiment determines explanatory variables regarding the estimation of the unknown relationship between the persons, and further determines the degree of importance (contribution) on estimation of the unknown relationship between the persons for each explanatory variable. Then, the SNS analysis system 10 weights the explanatory variable by its degree of importance to estimate the unknown relationship between the persons. As a result, since the SNS analysis system 10 performs estimation in which the feature of communication in the SNS are captured accurately as compared with, for example, a case where estimation is performed without calculating the degree of importance, accuracy with which an unknown relationship between the persons in the SNS is estimated can be enhanced.

When generating the estimation model 130, the model generation unit 13 may exclude a node (person) having an influence on the relationship between the communication history information 100 and the attribute information 103 related to a plurality of persons and the presence or absence of the relationship existing between the plurality of persons smaller than the reference. That is, when estimating a relationship existing between a plurality of persons, the model generation unit 13 may ignore a person who does not affect the estimation and is obviously unrelated to the plurality of persons as a node that is noise. The model generation unit 13 can use, for example, a Graph Denoising Policy Network (GDPNet) as an existing algorithm for excluding a node that is such noise. Then, the SNS analysis system 10 can reduce the processing load by excluding a node that is noise.

In a general system that estimates an event using a learned model, an estimation process is a black box, and only an estimation result is presented without presenting an estimation reason. Therefore, it is difficult for a user to grasp the basis of the estimation result output by the system. On the other hand, the SNS analysis system 10 according to the present example embodiment displays the reason for estimating the unknown relationship between the persons in the SNS based on the value of the explanatory variable on the display screen 200 of the management terminal device 20, for example, as illustrated in FIG. 8. With this configuration, the SNS analysis system 10 can improve the explanation about the reason for estimating the unknown relationship between the persons in the SNS.

Communication, via the SNS, to be analyzed by the SNS analysis system 10 is not limited to communication between the persons requiring attention who may commit a crime. For example, in a criminal investigation, the SNS analysis system 10 may estimate an unknown relationship existing between a crime victim and a certain person.

### Second Example Embodiment

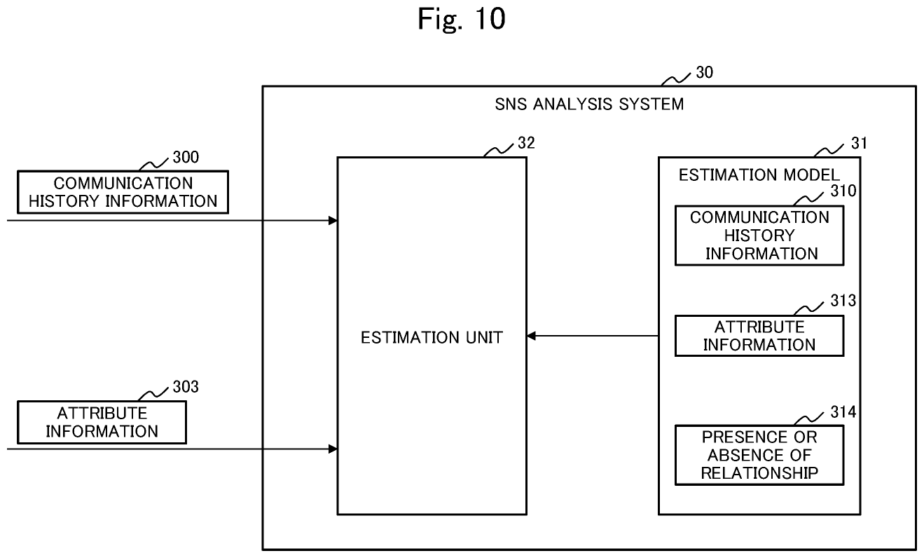

FIG. 10 is a block diagram illustrating a configuration of an SNS analysis system 30 according to the second example embodiment of the present invention. SNS analysis system 30 includes an estimation unit 32 that uses an estimation model 31. The estimation unit 32 is an example of an estimation means.

The estimation model 31 represents a relationship between communication history information 310 and attribute information 313 regarding the first plurality of persons (persons to be targets of machine learning) and the presence or absence 314 of a relationship existing between the first plurality of persons. As in the estimation model 130 according to the first example embodiment, for example, the estimation model 31 is a learned model representing a result of performing machine learning on a relationship between the communication history information 310, the attribute information 313, and the presence or absence 314 of a relationship existing between the first plurality of persons.

Communication history information 310 represents a time-series change in at least any of exchange of information between the first plurality of persons via the SNS and transmission of information related to each other by the first plurality of persons via the SNS. The communication history information 310 may be, for example, information similar to the communication history information 100 described with reference to FIGS. 2 to 4 with respect to the first example embodiment.

The attribute information 313 represents a time-series change in the attributes of the first plurality of persons, and may be, for example, information similar to the attribute information 103 described with reference to FIG. 4 with respect to the first example embodiment.

The estimation unit 32 estimates existence of the unknown relationship between the second plurality of persons based on communication history information 300 and attribute information 303 related to the second plurality of persons (persons for which the unknown relationship between the persons is to be estimated), and the estimation model 31.

When estimating existence of the unknown relationship between the persons, the estimation unit 32 extracts the feature of the time-series change regarding the communication and the attribute of the person in the SNS from the communication history information 300 and the attribute information 303, as in the estimation unit 14 according to the first example embodiment. At this time, the estimation unit 32 can use the predetermined algorithm (TGFN, STAR, Netwalk, etc.) described in the first example embodiment.

The SNS analysis system 30 according to the present example embodiment can improve accuracy with which existence of an unknown relationship between a plurality of persons in the SNS is estimated. This is because the SNS analysis system 30 estimates existence of the unknown relationship between the plurality of persons based on the estimation model 31 generated by using the result of extracting the feature of the time-series change from the information related to the communication between the plurality of persons via the SNS.

<Hardware Configuration Example>

Each unit in the SNS analysis system 10 illustrated in FIG. 1 or the SNS analysis system 30 illustrated in FIG. 10 in each of the above-described example embodiments can be achieved by dedicated hardware (HW) (electronic circuit). In FIGS. 1 and 10, at least the following configurations can be regarded as a function (processing) unit (software module) of a software program.
Acquisition unit 11
Graph generation unit 12
Model generation unit 13
Estimation units 14 and 32
Display control unit 15

The division of each unit illustrated in these drawings is a configuration for convenience of description, and various configurations can be assumed at the time of implementation. An example of a hardware environment in this case will be described with reference to FIG. 11.

FIG. 11 is a diagram for exemplarily describing a configuration of information processing system 900 (computer system) capable of achieving the SNS analysis system 10 according to the first example embodiment or the SNS analysis system 30 according to the second example embodiment of the present invention. That is, FIG. 11 illustrates a configuration of at least one computer (information processing apparatus) capable of achieving the SNS analysis systems 10 and 30 illustrated in FIGS. 1 and 10, and illustrates a hardware environment capable of achieving each function in the above-described example embodiment.

The information processing system 900 illustrated in FIG. 11 includes the following units as components, but may not include some of the following units.
CPU (Central_Processing_Unit) 901
ROM (Read_Only_Memory) 902
RAM (Random_Access_Memory) 903
Hard disk (storage unit) 904
Communication interface 905 with an external device
Bus 906 (communication line)
Reader/writer 908 capable of reading and writing data stored in a recording medium 907 such as a CD-ROM (Compact_Disc_Read_Only_Memory)
Input/output interface 909 such as a monitor, a speaker, and a keyboard

That is, the information processing system 900 including the above-described components is a general computer to which these components are connected via the bus 906. The information processing system 900 may include a plurality of CPUs 901 or may include a CPU 901 configured by a plurality of cores. The information processing system 900 may include a GPU (Graphical_Processing_Unit) (not illustrated) in addition to the CPU 901.

Then, the present invention described using the above-described example embodiment as an example supplies a computer program capable of achieving the following functions to the information processing system 900 illustrated in FIG. 11. The function is the above-described configuration in the block configuration diagram (FIGS. 1 and 10) referred to in the description of the example embodiment or the function of the flowchart (FIGS. 7 and 9). Thereafter, the present invention is achieved by reading, interpreting, and executing the computer program on the CPU 901 of the hardware. The computer program supplied into the device may be stored in a readable/writable volatile memory (RAM 903) or a non-volatile storage device such as the ROM 902 or the hard disk 904.

In the above case, a general procedure can be used at present as a method of supplying the computer program into the hardware. Examples of the procedure include a method of installing the program in the apparatus via various recording media 907 such as a CD-ROM, a method of downloading the program from the outside via a communication line such as the Internet, and the like. In such a case, the present invention can be understood to be configured by a code constituting the computer program or the recording medium 907 storing the code.

The present invention is described above using the above-described example embodiments as exemplary examples. However, the present invention is not limited to the above-described example embodiments. That is, the present invention can have various aspects that can be understood by those skilled in the art within the scope of the present invention.

Note that part or all of each example embodiments described above can also be described as the following Supplementary Notes. However, the present invention exemplarily described by the above-described example embodiments is not limited to the following.

(Supplementary Note 1)

An SNS analysis system including

an estimation means configured to estimate, based on an estimation model representing a relationship between communication history information and attribute information related to a first plurality of persons and presence or absence of a relationship existing between the first plurality of persons and the communication history information and the attribute information related to a second plurality of persons, existence of an unknown relationship between the second plurality of persons, wherein

the communication history information represents a time-series change in at least any of exchange of information between the first plurality of persons or the second plurality of persons via an SNS and transmission of information related to each other by the first plurality of persons or the second plurality of persons via the SNS, and

the attribute information indicates a time-series change in attributes of the first plurality of persons or the second plurality of persons.

(Supplementary Note 2)

The SNS analysis system according to Supplementary Note 1, further including

a display control means configured to control a display device to display a reason for estimating existence of an unknown relationship between the second plurality of persons.

(Supplementary Note 3)

The SNS analysis system according to Supplementary Note 2, wherein

the communication history information indicates a follow result of an SNS between the first plurality of persons or the second plurality of persons.

(Supplementary Note 4)

The SNS analysis system according to Supplementary Note 2 or 3, wherein

the communication history information includes information posted on an SNS by the first plurality of persons or the second plurality of persons.

(Supplementary Note 5)

The SNS analysis system according to Supplementary Note 4, wherein

the posted information includes at least any of a text, a voice, and an image.

(Supplementary Note 6)

The SNS analysis system according to any one of Supplementary Notes 2 to 5, wherein

the communication history information indicates locations where the first plurality of persons or the second plurality of persons has performed communication by operating terminal devices.

(Supplementary Note 7)

The SNS analysis system according to any one of Supplementary Notes 2 to 6, wherein

the attribute information represents at least any of a criminal record of each of the first plurality of persons or the second plurality of persons and a situation in which the each person belongs to an organization.

(Supplementary Note 8)

The SNS analysis system according to any one of Supplementary Notes 2 to 7, further including

a graph generation means configured to generate a graph representing the communication history information.

(Supplementary Note 9)

The SNS analysis system according to Supplementary Note 8, wherein

the graph includes a node representing each of the first plurality of persons or the second plurality of persons and an edge representing each relationship between the first plurality of persons or the second plurality of persons via an SNS.

(Supplementary Note 10)

The SNS analysis system according to Supplementary Note 9, further including

a model generation means configured to generate the estimation model based on communication history information and attribute information related to the first plurality of persons in a predetermined period, and presence or absence of a relationship, existing between the first plurality of persons, that is unknown in the predetermined period but is known after the predetermined period.

(Supplementary Note 11)

The SNS analysis system according to Supplementary Note 10, wherein

the model generation means extracts a feature of a time-series change in a relationship between the first plurality of persons via an SNS using a predetermined algorithm from the graph to which presence or absence of a relationship, existing between the first plurality of persons, that is unknown in the predetermined period is assigned as a label, and then determines an explanatory variable of existence of an unknown relationship between the first plurality of persons based on a result of the extraction to generate the estimation model including the explanatory variable.

(Supplementary Note 12)

The SNS analysis system according to Supplementary Note 11, wherein

the model generation means generates the estimation model excluding a node in which an influence on a relationship between the communication history information and the attribute information related to the first plurality of persons and presence or absence of a relationship existing between the first plurality of persons is smaller than a reference.

(Supplementary Note 13)

The SNS analysis system according to Supplementary Note 11 or 12, wherein

the graph generation means generates the graph including the attribute information, and

the model generation means determines, from the graph, the explanatory variable related to an attribute of each of the first plurality of persons.

(Supplementary Note 14)

The SNS analysis system according to any one of Supplementary Notes 11 to 13, wherein

the model generation means determines a degree of importance on estimation of existence of the unknown relationship for each of a plurality of the explanatory variables, and

the estimation means estimates existence of the unknown relationship based on the degree of importance.

(Supplementary Note 15)

The SNS analysis system according to Supplementary Note 14, wherein

the model generation means determines the degree of importance different for each of the first plurality of persons for the same explanatory variable.

(Supplementary Note 16)

The SNS analysis system according to Supplementary Note 14 or 15, wherein

the display control means causes the display device to display names of the explanatory variables side by side in descending order of the degree of importance and display the estimation reason in a mode of displaying values of the explanatory variables.

(Supplementary Note 17)

An SNS analysis device including

an estimation means configured to estimate, based on an estimation model representing a relationship between communication history information and attribute information related to a first plurality of persons and presence or absence of a relationship existing between the first plurality of persons and the communication history information and the attribute information related to a second plurality of persons, existence of an unknown relationship between the second plurality of persons, wherein

the communication history information represents a time-series change in at least any of exchange of information between the first plurality of persons or the second plurality of persons via an SNS and transmission of information related to each other by the first plurality of persons or the second plurality of persons via the SNS, and

the attribute information indicates a time-series change in attributes of the first plurality of persons or the second plurality of persons.

(Supplementary Note 18)

An SNS analysis method including

an information processing system estimating, based on an estimation model representing a relationship between communication history information and attribute information related to a first plurality of persons and presence or absence of a relationship existing between the first plurality of persons and the communication history information and the attribute information related to a second plurality of persons, existence of an unknown relationship between the second plurality of persons, wherein

the communication history information represents a time-series change in at least any of exchange of information between the first plurality of persons or the second plurality of persons via an SNS and transmission of information related to each other by the first plurality of persons or the second plurality of persons via the SNS, and

the attribute information indicates a time-series change in attributes of the first plurality of persons or the second plurality of persons.

(Supplementary Note 19)

A recording medium storing an SNS analysis program for causing a computer to execute

an estimation process of estimating, based on an estimation model representing a relationship between communication history information and attribute information related to a first plurality of persons and presence or absence of a relationship existing between the first plurality of persons and the communication history information and the attribute information related to a second plurality of persons, existence of an unknown relationship between the second plurality of persons, wherein

the communication history information represents a time-series change in at least any of exchange of information between the first plurality of persons or the second plurality of persons via an SNS and transmission of information related to each other by the first plurality of persons or the second plurality of persons via the SNS, and

the attribute information indicates a time-series change in attributes of the first plurality of persons or the second plurality of persons.

### INDUSTRIAL APPLICABILITY

The present invention can be used for estimation of any case event that can occur through an SNS, for example, estimation of a special fraud group, estimation of an assailant or a victim of an abduction case, estimation of a person requiring attention such as a terrorist, a crime premonitor, or a suicide wanna-be, and transaction of illegal drugs.

### REFERENCE SIGNS LIST

10 SNS analysis system
100 communication history information
101 follow result information
102 posted information
103 attribute information
11 acquisition unit
12 graph generation unit
120 graph
13 model generation unit
130 estimation model
14 estimation unit
15 display control unit
20 management terminal device
200 display screen
30 SNS analysis system
300 communication history information
303 attribute information
31 estimation model
310 communication history information
313 attribute information
314 presence or absence of relationship
32 estimation unit
900 information processing system
901 CPU
902 ROM
903 RAM
904 hard disk (storage unit)
905 communication interface
906 bus
907 recording medium
908 reader/writer
909 input/output interface

What is claimed is:

1. An SNS analysis system comprising:
a memory storing instructions; and
one or more processors configured to execute the instructions to:
estimate, based on an estimation model representing a relationship between communication history information and attribute information related to a first plurality of persons and presence or absence of a relationship existing between the first plurality of persons and the communication history information and the attribute information related to a second plurality of persons, existence of an unknown relationship between the second plurality of persons, wherein
the communication history information represents a time-series change in at least any of exchange of information between the first plurality of persons or the second plurality of persons via an SNS and transmission of information related to each other by the first plurality of persons or the second plurality of persons via the SNS, and
the attribute information indicates a time-series change in attributes of the first plurality of persons or the second plurality of persons.

2. The SNS analysis system according to claim 1, wherein the one or more processors are further configured to execute the instructions to:
control a display device to display a reason for estimating existence of an unknown relationship between the second plurality of persons.

3. The SNS analysis system according to claim 2, wherein
the communication history information indicates a follow result of an SNS between the first plurality of persons or the second plurality of persons.

4. The SNS analysis system according to claim 2, wherein
the communication history information includes information posted on an SNS by the first plurality of persons or the second plurality of persons.

5. The SNS analysis system according to claim 4, wherein
the posted information includes at least any of a text, a voice, and an image.

6. The SNS analysis system according to claim 2, wherein
the communication history information indicates locations where the first plurality of persons or the second plurality of persons has performed communication by operating terminal devices.

7. The SNS analysis system according to claim 2, wherein
the attribute information represents at least any of a criminal record of each of the first plurality of persons or the second plurality of persons and a situation in which the each person belongs to an organization.

8. The SNS analysis system according to claim 2, wherein the one or more processors are further configured to execute the instructions to
generate a graph representing the communication history information.

9. The SNS analysis system according to claim 8, wherein
the graph includes a node representing each of the first plurality of persons or the second plurality of persons and an edge representing a relationship between the first plurality of persons or the second plurality of persons via an SNS.

10. The SNS analysis system according to claim 9, wherein the one or more processors are further configured to execute the instructions to:
generate the estimation model based on communication history information and attribute information related to the first plurality of persons in a predetermined period, and presence or absence of a relationship, existing between the first plurality of persons, that is unknown in the predetermined period but is known after the predetermined period.

11. The SNS analysis system according to claim 10, wherein the one or more processors are further configured to execute the instructions to:
extract a feature of a time-series change in a relationship existing between the first plurality of persons via an SNS using a predetermined algorithm from the graph to which presence or absence of a relationship, existing between the first plurality of persons, that is unknown in the predetermined period is assigned as a label, and then
determine an explanatory variable of existence of an unknown relationship between the first plurality of persons based on a result of the extraction to generate the estimation model including the explanatory variable.

12. The SNS analysis system according to claim 11, wherein the one or more processors are further configured to execute the instructions to:
generate the estimation model excluding a node in which an influence on a relationship between the communication history information and the attribute information related to the first plurality of persons and presence or absence of a relationship existing between the first plurality of persons is smaller than a reference.

13. The SNS analysis system according to claim 11, wherein the one or more processors are further configured to execute the instructions to:
generate the graph including the attribute information, and
determine, from the graph, the explanatory variable related to an attribute of each of the first plurality of persons.

14. The SNS analysis system according to claim 11, wherein the one or more processors are further configured to execute the instructions to:
determine a degree of importance on estimation of existence of the unknown relationship for each of a plurality of the explanatory variables, and
estimate existence of the unknown relationship based on the degree of importance.

15. The SNS analysis system according to claim 14, wherein the one or more processors are further configured to execute the instructions to:
determine the degree of importance different for each person among the first plurality of persons for the same explanatory variable.

16. The SNS analysis system according to claim 14, wherein the one or more processors are further configured to execute the instructions to:
cause the display device to display names of the explanatory variables side by side in descending order of the degree of importance and display the estimation reason in a mode of displaying values of the explanatory variables.

17. (canceled)

18. An SNS analysis method comprising:
an information processing system estimating, based on an estimation model representing a relationship between communication history information and attribute information related to a first plurality of persons and presence or absence of a relationship existing between the first plurality of persons and the communication history information and the attribute information related to a second plurality of persons, existence of an unknown relationship between the second plurality of persons, wherein
the communication history information represents a time-series change in at least any of exchange of information between the first plurality of persons or the second plurality of persons via an SNS and transmission of information related to each other by the first plurality of persons or the second plurality of persons via the SNS, and
the attribute information indicates a time-series change in attributes of the first plurality of persons or the second plurality of persons.

19. A non-transitory computer-readable recording medium storing an SNS analysis program for causing a computer to execute:
an estimation process of estimating, based on an estimation model representing a relationship between communication history information and attribute information related to a first plurality of persons and presence or absence of a relationship existing between the first plurality of persons and the communication history information and the attribute information related to a second plurality of persons, existence of an unknown relationship between the second plurality of persons, wherein
the communication history information represents a time-series change in at least any of exchange of information between the first plurality of persons or the second plurality of persons via an SNS and transmission of information related to each other by the first plurality of persons or the second plurality of persons via the SNS, and
the attribute information indicates a time-series change in attributes of the first plurality of persons or the second plurality of persons.
